(19) United States
(12) Patent Application Publication
(10) Pub. No.: US 2010/0267386 A1
(43) Pub. Date: Oct. 21, 2010

(54) METHODS AND APPARATUS FOR FACILITATING HANDOFF BETWEEN A FEMTOCELL BASE STATION AND A CELLULAR BASE STATION

(75) Inventors: Patrick Lim, San Diego, CA (US); Nitin Pant, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/425,493

(22) Filed: Apr. 17, 2009

(51) Int. Cl. H04W 36/00; H04M 1/00

(52) U.S. Cl. 455/436; 455/561

(57) ABSTRACT

A user may enter information about a cellular base station into a femtocell base station. A user may enter information about a femtocell base station into a subscriber station. A femtocell base station may receive a neighbor list from a cellular base station, and broadcast the neighbor list to subscriber stations that are located within a coverage area of the femtocell base station. When a subscriber station is being served by a femtocell base station, the subscriber station may receive a neighbor list from the femtocell base station and scan for potential handoff candidates using the neighbor list. When a subscriber station is being served by a cellular base station, the subscriber station may scan for potential handoff candidates using a neighbor list received from the cellular base station and also using the femtocell base station information that the user entered.

### TECHNICAL FIELD

The present disclosure relates generally to communication systems. More specifically, the present disclosure relates to methods and apparatus for facilitating handoff between a femtocell base station and a cellular base station.

### BACKGROUND

Wireless communication systems have become an important means by which many people worldwide have come to communicate. A wireless communication system may provide communication for a number of subscriber stations, each of which may be serviced by a base station. As used herein, the term “subscriber station” refers to an electronic device that may be used for voice and/or data communication over a wireless communication system. Examples of subscriber stations include cellular phones, personal digital assistants (PDAs), handheld devices, wireless modems, laptop computers, personal computers, etc. A subscriber station may alternatively be referred to as an access terminal, a mobile terminal, a mobile station, a remote station, a user terminal, a terminal, a subscriber unit, a mobile device, a wireless device, user equipment, or some other similar terminology. The term “base station” refers to a wireless communication station that is installed at a fixed location and used to communicate with subscriber stations. A base station may alternatively be referred to as an access point, a Node B, an evolved Node B, or some other similar terminology.

A subscriber station may communicate with one or more base stations via transmissions on the uplink and the downlink. The uplink (or reverse link) refers to the communication link from the subscriber station to the base station, and the downlink (or forward link) refers to the communication link from the base station to the subscriber station.

The resources of a wireless communication system (e.g., bandwidth and transmit power) may be shared among multiple subscriber stations. A variety of multiple access techniques are known, including code division multiple access (CDMA), time division multiple access (TDMA), frequency division multiple access (FDMA), orthogonal frequency division multiple access (OFDMA), single-carrier frequency division multiple access (SC-FDMA), and so forth.

Benefits may be realized by improved methods and apparatus related to the operation of wireless communication systems.

### SUMMARY

A method for a femtocell base station to facilitate femtocell-to-cellular base station handoff is disclosed. The femtocell base station may receive information about a cellular base station from a user. The femtocell base station may receive a neighbor list from the cellular base station. The neighbor list may include information about other cellular base stations. The femtocell base station may broadcast the neighbor list to subscriber stations that are located within a coverage area of the femtocell base station.

A method for a subscriber station to facilitate femtocell-to-cellular base station handoff is also disclosed. The subscriber station may receive a neighbor list from a femtocell base station when the subscriber station is being served by the femtocell base station. The neighbor list may include information about cellular base stations. The subscriber station may scan for potential handoff candidates using the neighbor list that is received from the femtocell base station.

A method for a subscriber station to facilitate cellular-to-femtocell base station handoff is also disclosed. The subscriber station may receive information about a femtocell base station from a user. The subscriber station may receive a neighbor list from a cellular base station. The subscriber station may scan for potential handoff candidates using the neighbor list and the information about the femtocell base station, so that the femtocell base station is considered as one of the potential handoff candidates.

A femtocell base station that is configured to facilitate femtocell-to-cellular base station handoff is also disclosed. The femtocell base station includes a processor and memory in electronic communication with the processor. Instructions are stored in the memory. The instructions may be executable by the processor to receive information about a cellular base station from a user. The instructions may also be executable by the processor to receive a neighbor list from the cellular base station. The neighbor list may include information about other cellular base stations. The instructions may also be executable by the processor to broadcast the neighbor list to subscriber stations that are located within a coverage area of the femtocell base station.

A subscriber station that is configured to facilitate femtocell-to-cellular base station handoff is also disclosed. The subscriber station includes a processor and memory in electronic communication with the processor. Instructions are stored in the memory. The instructions may be executable by the processor to receive a neighbor list from a femtocell base station when the subscriber station is being served by the femtocell base station. The neighbor list may include information about cellular base stations. The instructions may also be executable by the processor to scan for potential handoff candidates using the neighbor list that is received from the femtocell base station.

A subscriber station that is configured to facilitate cellular-to-femtocell base station handoff is also disclosed. The subscriber station includes a processor and memory in electronic communication with the processor. Instructions are stored in the memory. The instructions may be executable by the processor to receive information about a femtocell base station from a user. The instructions may also be executable by the processor to receive a neighbor list from a cellular base station. The instructions may also be executable by the processor to scan for potential handoff candidates using the neighbor list and the information about the femtocell base station, so that the femtocell base station is considered as one of the potential handoff candidates.

A femtocell base station that is configured to facilitate femtocell-to-cellular base station handoff is also disclosed. The femtocell base station may include means for receiving information about a cellular base station from a user. The femtocell base station may also include means for receiving a neighbor list from the cellular base station. The neighbor list may include information about other cellular base stations. The neighbor list may also include means for broadcasting the neighbor list to subscriber stations that are located within a coverage area of the femtocell base station.

A subscriber station that is configured to facilitate femtocell-to-cellular base station handoff is also disclosed. The subscriber station may include means for receiving a neighbor list from a femtocell base station when the subscriber station is being served by the femtocell base station. The neighbor list may include information about cellular base stations. The subscriber station may also include means for scanning for potential handoff candidates using the neighbor list that is received from the femtocell base station.

A subscriber station that is configured to facilitate cellular-to-femtocell base station handoff is also disclosed. The subscriber station may include means for receiving information about a femtocell base station from a user. The subscriber station may also include means for receiving a neighbor list from a cellular base station. The subscriber station may also include means for scanning for potential handoff candidates using the neighbor list and the information about the femtocell base station, so that the femtocell base station is considered as one of the potential handoff candidates.

A computer-program product for a femtocell base station to facilitate femtocell-to-cellular base station handoff is also disclosed. The computer-program product includes a computer-readable medium having instructions thereon. The instructions may include code for receiving information about a cellular base station from a user. The instructions may also include code for receiving a neighbor list from the cellular base station. The neighbor list may include information about other cellular base stations. The instructions may also include code for broadcasting the neighbor list to subscriber stations that are located within a coverage area of the femtocell base station.

A computer-program product for a subscriber station to facilitate femtocell-to-cellular base station handoff is also disclosed. The computer-program product includes a computer-readable medium having instructions thereon. The instructions may include code for receiving a neighbor list from a femtocell base station when the subscriber station is being served by the femtocell base station. The neighbor list may include information about cellular base stations. The instructions may also include code for scanning for potential handoff candidates using the neighbor list that is received from the femtocell base station.

A computer-program product for a subscriber station to facilitate cellular-to-femtocell base station handoff is also disclosed. The computer-program product includes a computer-readable medium having instructions thereon. The instructions may include code for receiving information about a femtocell base station from a user. The instructions may also include code for receiving a neighbor list from a cellular base station. The instructions may also include code for scanning for potential handoff candidates using the neighbor list and the information about the femtocell base station, so that the femtocell base station is considered as one of the potential handoff candidates.

### BRIEF DESCRIPTION OF THE DRAWINGS

FIG. 1 shows an example of a wireless communication system in which the methods and apparatus disclosed herein may be utilized;

FIG. 2 illustrates various components within a WiMAX network;

FIGS. 3A and 3B illustrate a frame structure within a WiMAX network;

FIG. 4 illustrates an example showing how a femtocell base station may be utilized within a WiMAX network;

FIG. 5 illustrates a femtocell base station information storing cellular base station information and a subscriber station storing femtocell base station information;

FIG. 6 illustrates a method for allowing a subscriber station to receive a neighbor list that is broadcast by a cellular base station while the subscriber station is connected to a femtocell base station;

FIG. 7 illustrates means-plus-function blocks corresponding to the method of FIG. 6;

FIG. 8 illustrates a method for facilitating handoff of a subscriber station from a femtocell base station to a cellular base station;

FIG. 9 illustrates means-plus-function blocks corresponding to the method of FIG. 8;

FIG. 10 illustrates a method for facilitating handoff of a subscriber station from a cellular base station to a femtocell base station;

FIG. 11 illustrates means-plus-function blocks corresponding to the method of FIG. 10; and

FIG. 12 illustrates certain components that may be included within a wireless device.

### DETAILED DESCRIPTION

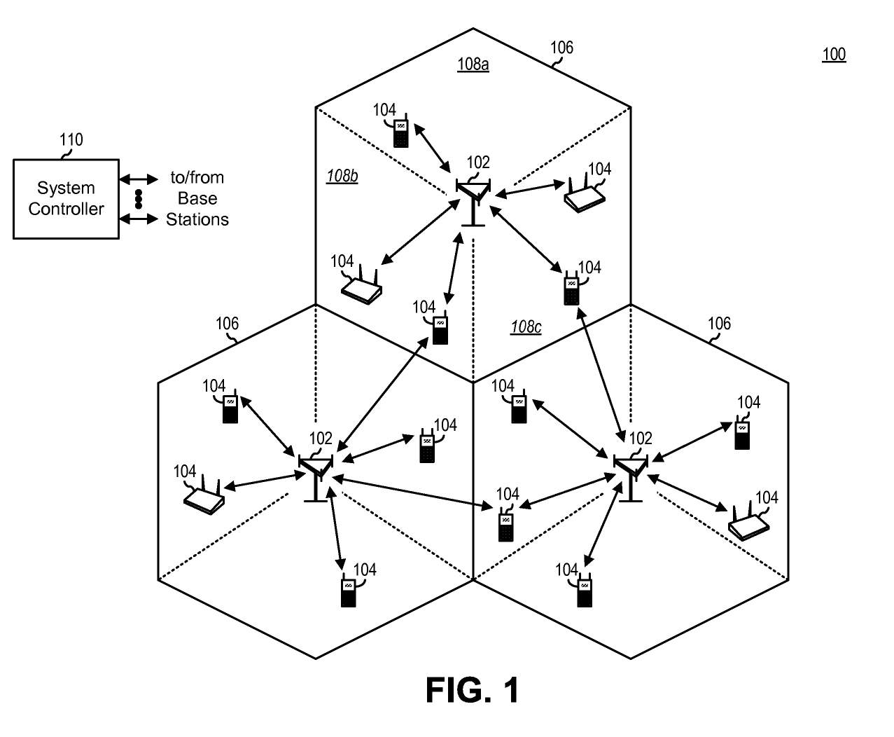

FIG. 1 shows an example of a wireless communication system 100 in which the methods and apparatus disclosed herein may be utilized. The wireless communication system 100 includes multiple base stations (BS) 102 and multiple subscriber stations (SS) 104. Each base station 102 provides communication coverage for a particular geographic area 106. The term “cell” can refer to a base station 102 and/or its coverage area 106 depending on the context in which the term is used.

To improve system capacity, a base station coverage area 106 may be partitioned into multiple smaller areas, e.g., three smaller areas 108a, 108b, and 108c. Each smaller area 108a, 108b, 108c may be served by a respective base transceiver station (BTS). The term “sector” can refer to a BTS and/or its coverage area 108 depending on the context in which the term is used. For a sectorized cell, the BTSs for all sectors of that cell are typically co-located within the base station 102 for the cell.

Subscriber stations 104 are typically dispersed throughout the system 100. A subscriber station 104 may communicate with zero, one, or multiple base stations 104 on the downlink and/or uplink at any given moment.

For a centralized architecture, a system controller 110 may couple to the base stations 102 and provide coordination and control for the base stations 102. The system controller 110 may be a single network entity or a collection of network entities. For a distributed architecture, base stations 102 may communicate with one another as needed.

The terms “system” and “network” may be used interchangeably herein. Thus, the wireless communication system 100 shown in FIG. 1 may also be referred to as a wireless communication network 100.

The IEEE 802.16 Working Group on Broadband Wireless Access Standards aims to prepare formal specifications for the global deployment of broadband Wireless Metropolitan Area Networks. Although the 802.16 family of standards is officially called WirelessMAN, it has been called “WiMAX” (which stands for the “Worldwide Interoperability for Microwave Access”) by an industry group called the WiMAX Forum. Thus, the term “WiMAX” refers to a standards-based broadband wireless technology that provides high-throughput broadband connections over long distances. The term “WiMAX system” refers to a wireless communication system that is configured in accordance with one or more WiMAX standards.

The bandwidth and range of WiMAX make it suitable for a number of potential applications, including providing data and telecommunications services, connecting Wi-Fi hotspots with other parts of the Internet, providing a wireless alternative to cable and digital subscriber line for “last mile” broadband access, providing portable connectivity, etc.

The base stations 102 and the subscriber stations 104 in the wireless communication system 100 shown in FIG. 1 may be configured to support a WiMAX standard. Thus, the wireless communication system 100 in FIG. 1 may be referred to herein as a WiMAX system 100 (or WiMAX network 100).

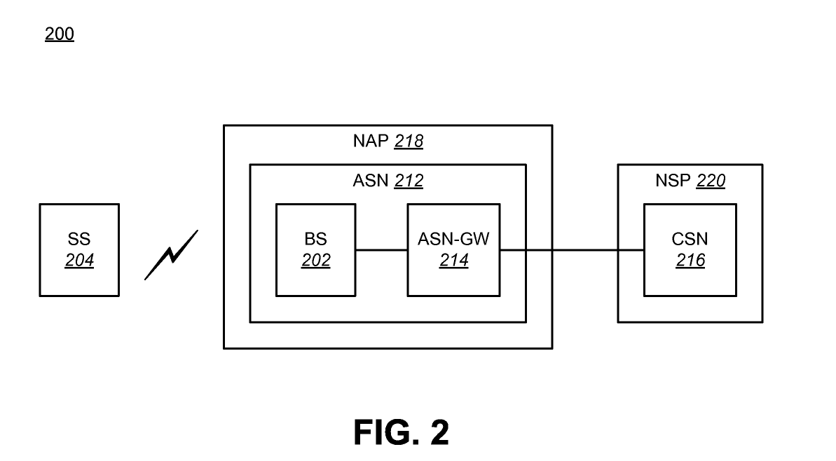

Reference is now made to FIG. 2. The WiMAX Forum's Network Working Group (NWG) has developed a network reference model to serve as an architecture framework for WiMAX deployments and to ensure interoperability among various WiMAX equipment and operators. A WiMAX network 200 may be logically divided into three parts: (1) subscriber stations 204 used by the end user to access the network 200; (2) the access service network (ASN) 212, which includes one or more base stations 202 and one or more ASN gateways (ASN-GWs) 214 that form the radio access network; and (3) the connectivity service network (CSN) 216, which provides IP connectivity and IP core network functions.

The architecture framework allows for a network access provider (NAP) 218 and a network services provider (NSP) 220. The NAP 218 owns and operates the ASN 212. The NSP 220 provides IP connectivity and WiMAX services to subscribers using the ASN 212 infrastructure provided by one or more NAPs 218.

In a WiMAX network 200, a base station 202 is responsible for providing the air interface to the subscriber station 204. Additional functions that may be part of the base station 202 may be thought of as micromobility management functions, such as handoff triggering and tunnel establishment, radio resource management, QoS policy enforcement, traffic classification, DHCP (dynamic host control protocol) proxy, key management, session management, multicast group management, etc.

The ASN-GW 214 typically acts as a layer 2 traffic aggregation point within an ASN 212. Additional functions that may be part of the ASN-GW 214 include intra-ASN 212 location management and paging, radio resource management and admission control, caching of subscriber profiles and encryption keys, AAA (authentication, authorization, accounting) client functionality, establishment and management of mobility tunnel with base stations, QoS and policy enforcement, foreign agent functionality for mobile IP, routing to the selected CSN 216, etc.

The CSN 216 provides connectivity to the Internet, ASP (application service provider), other public networks, corporate networks, etc. The CSN 216 may be owned by the NSP 220 and may include AAA servers that support authentication for the devices, users, and specific services. The CSN 216 may also provide per user policy management of QoS and security. The CSN 216 may also be responsible for IP address management, support for roaming between different NSPs 220, location management between ASNs 212, and mobility and roaming between ASNs 212. Furthermore, the CSN 216 may also provide gateways and interworking with other networks, such as the PSTN (public switched telephone network), 3GPP, 3GPP2, etc.

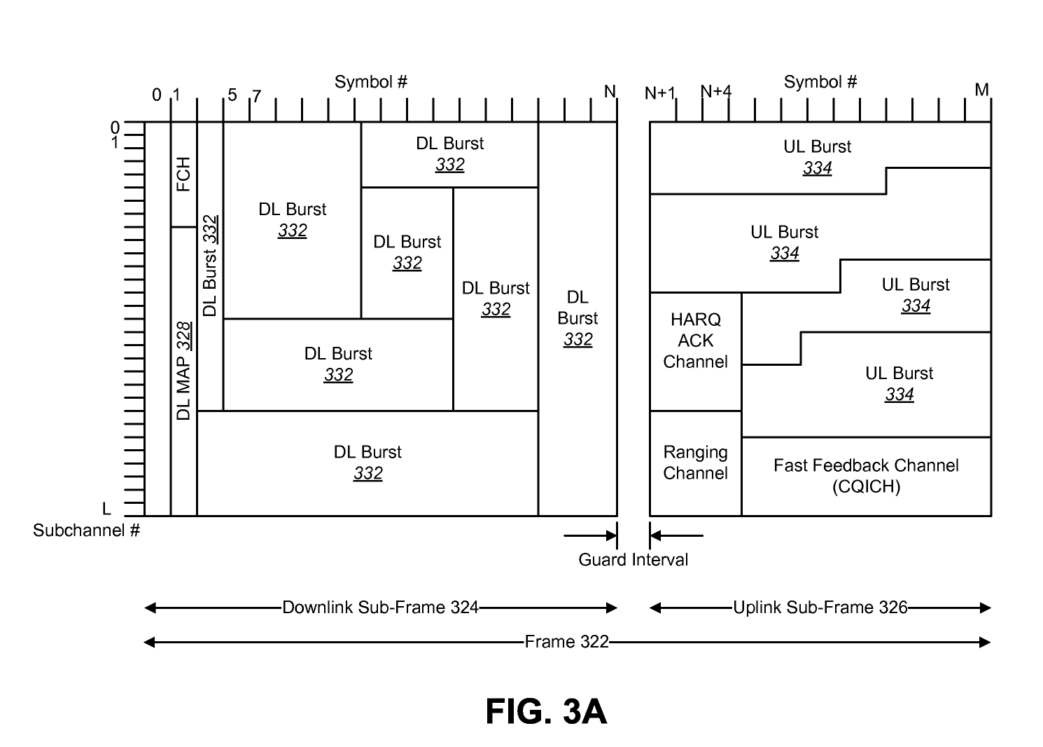

Reference is now made to FIGS. 3A and 3B. In current WiMAX standards, the medium access control (MAC) layer supports time division duplexing (TDD). In TDD mode, a frame 322 may be divided into two subframes: a downlink subframe 324 followed by an uplink subframe 326. The downlink subframe 324 and the uplink subframe 326 may be transmitted on the same carrier frequency at different times.

During the downlink subframe 324, a downlink MAP (DL-MAP) 328 and an uplink MAP (UL-MAP) 330 may be transmitted. The information in the DL-MAP 328 and the UL-MAP 330 makes it possible for a subscriber station 204 to identify the downlink bursts 332 and the uplink bursts 334, respectively, that have been allocated to it by the base station 202. The DL-MAP 328 and the UL-MAP 330 may include the burst profile for each subscriber station 204, which defines the modulation and coding scheme that is used. Since the DL-MAP 328 and the UL-MAP 330 include important information, they are often sent over a very reliable link.

A downlink channel descriptor (DCD) 336, which includes configuration parameters relevant to the downlink, may also be transmitted during the downlink subframe 324. The DCD 336 may be transmitted periodically by the base station 202. The following are examples of configuration parameters that may be included in the DCD 336: the mapping of downlink interval usage code (DIUC) values to burst profiles, the transmit transition gap (TTG), the receive transition gap (RTG), the base station's 202 effective isotropic radiated power (EIRP), the maximum EIRP at the base station 202 for initial ranging, the downlink center frequency, the base station 202 identifier, the hybrid automatic repeat request (HARQ) acknowledgement (ACK) delay for an uplink burst 334, the maximum number of retransmissions of the downlink HARQ, handoff types that are supported, the handoff add threshold, the handoff delete threshold, the anchor switch report (ASR) slot length and switching period, the base station 202 restart count, the MAC version, etc.

An uplink channel descriptor (UCD) 338, which includes configuration parameters relevant to the uplink, may also be transmitted during the downlink subframe 324. The UCD 338 may also be transmitted periodically by the base station 202. The following are examples of configuration parameters that may be included in the UCD 338: the mapping of uplink interval usage code (UIUC) values to burst profiles, the uplink center frequency, the ranging backoff start and end, the start of ranging code groups, the number of initial ranging codes, the number of periodic ranging codes, the number of handoff ranging codes, the permbase parameter of subcarrier permutation used for the uplink, the uplink allocated subchannel bitmap, the HARQ ACK delay for the downlink burst 332, the maximum number of retransmissions of the uplink HARQ, the size of the channel-quality indicator channel (CQICH) identifier field, the band adaptive modulation and coding (AMC) allocation and release thresholds, band AMC allocation and release timers, subscriber station-specific up/down power offset adjustment steps, the maximum/minimum level of subscriber station-specific power adjustment, the normalized carrier-to-noise override, etc.

The present disclosure relates generally to femtocells within a wireless communication network, such as a WiMAX network 200. A femtocell is a relatively small base station, generally designed for use in residential or small business environments. Typically, a femtocell base station connects to a service provider's network via broadband (such as DSL or cable). Femtocell base stations may be utilized in WiMAX networks 200, as well as many other kinds of wireless communication networks, such as UMTS (Universal Mobile Telecommunication System), GSM (Global System for Mobiles), CDMA2000, TD-SCDMA (Time Division-Synchronous CDMA), LTE (Long Term Evolution), etc.

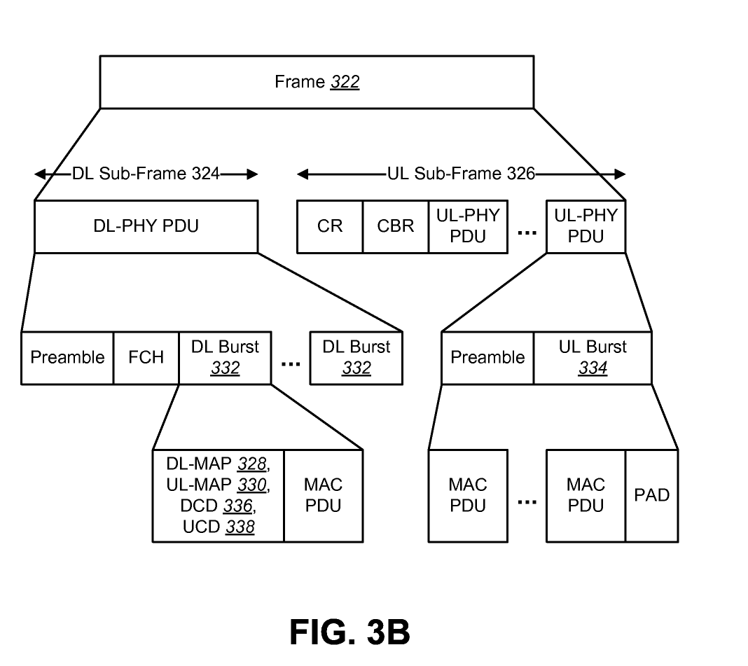

FIG. 4 illustrates an example showing how a femtocell base station 440 may be utilized within a WiMAX network 400. The cellular base station 402, subscriber station 404, ASN 412, ASN-GW 414, CSN 416, NAP 418 and NSP 420 shown in FIG. 4 are similar to the base station 202, subscriber station 204, ASN 212, ASN-GW 214, CSN 216, NAP 218 and NSP 220 discussed previously in connection with FIG. 2.

A femtocell base station 440 may be connected to the CSN 416 of the WiMAX network 400 via a broadband Internet connection 442 and a femto gateway 444. The femto gateway 444 is a high capacity node that can support a large number (e.g., hundreds of thousands) of femtocell base stations 440. The femto gateway 444 consolidates the signaling and voice/data traffic from this large number of femtocell base stations 440 and presents it to the CSN 416, where it is dealt with as normal.

When a subscriber station 404 moves from a location outside the range of the femtocell base station 440 to a location within the range of the femtocell base station 440, it would probably be beneficial for the subscriber station 404 to initiate a handoff from its current serving cellular base station 402 to the femtocell base station 440. This is because the signal that the subscriber station 404 receives from the femtocell base station 440 is probably a higher quality signal than the signal that it receives from the cellular base station 402. When the subscriber station 404 is connected to the femtocell base station 440, the subscriber station 404 can operate as it usually would within the WiMAX network 400 (e.g., the subscriber station 404 can be used to make and receive phone calls, send and receive email, browse the World Wide Web, etc.).

Currently, if a subscriber station 404 is connected to a WiMAX femtocell base station 440, it is not possible for the subscriber station 404 to know the parameters of the WiMAX cellular base station 402. This poses a problem when the subscriber station 404 starts to move away from the femtocell base station 440 and loses the femtocell base station's 440 signal. Service may be interrupted while the subscriber station 404 scans for possible cellular base stations 402 and performs the initial network entry procedure with a cellular base station 402.

The opposite is also true, i.e., if a subscriber station 404 is connected to a WiMAX cellular base station 402, it is not possible for the subscriber station 404 to know the parameters of the WiMAX femtocell base station 440. Therefore, the subscriber station 404 may not know when it has moved to a location within the coverage area of the femtocell base station 440.

The present disclosure relates to facilitating handoff from a femtocell base station 440 to a cellular base station 402, and vice versa. Although the methods and apparatus disclosed herein will be described in connection with a WiMAX system, the scope of the present disclosure is not limited in this regard. The methods and apparatus disclosed herein may be utilized in connection with other wireless technologies, such as UMTS (Universal Mobile Telecommunications System), GSM (Global System for Mobile communications), CDMA2000, etc.

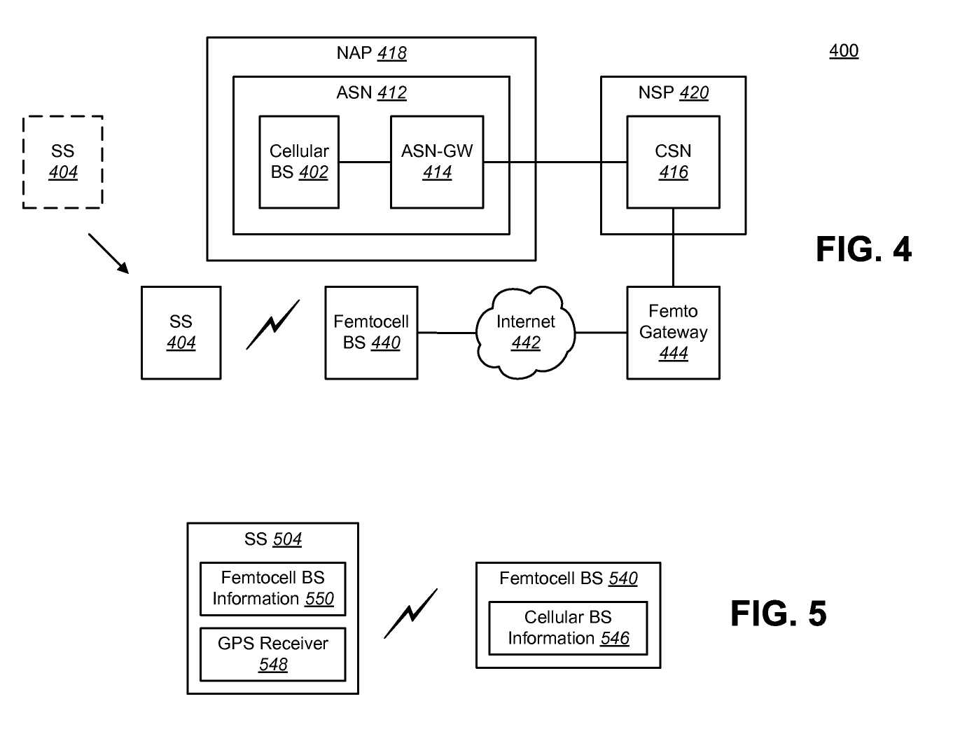

Reference is now made to FIG. 5. In accordance with the present disclosure, a user enters cellular base station information 546 into a femtocell base station 540, and the cellular base station information 546 may be stored by the femtocell base station 540. Similarly, a user enters femtocell base station information 550 into the subscriber station 504, and the femtocell base station information 550 may be stored by the subscriber station 504. The cellular base station information 546 and/or the femtocell base station information 550 may include an operator identifier, RF (radio frequency) channel frequency information, RF channel bandwidth, FFT (fast Fourier transform) size, cyclic prefix size, an NAP identifier, an NSP identifier, a capabilities profile, etc. In this context, the term “user” refers to a person, organization, or other entity that employs the services provided by a WiMAX network 400.

The subscriber station 504 is also shown with a Global Positioning System (GPS) receiver 548. The GPS receiver 548 may be used to determine whether the subscriber station 504 is located within the coverage area of the femtocell base station 540. This will be described in greater detail below.

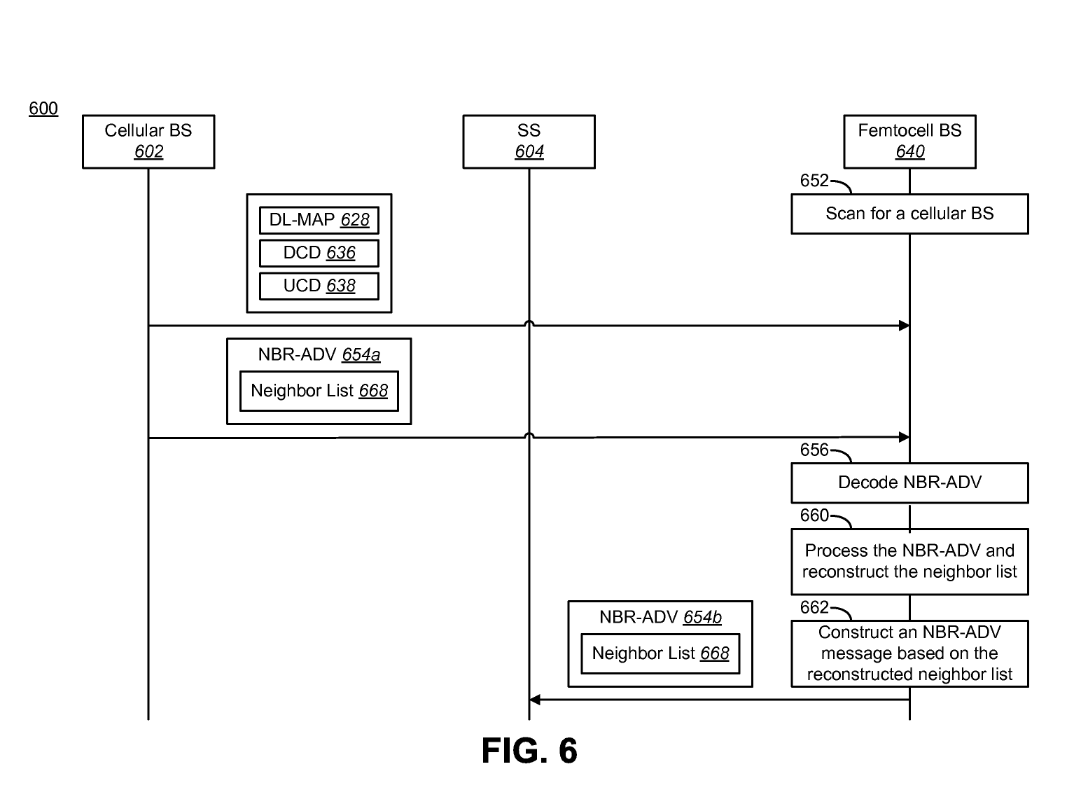

FIG. 6 illustrates a method 600 for allowing a subscriber station 604 to receive a neighbor list 668 that is broadcast by a cellular base station 602 while the subscriber station 604 is connected to a femtocell base station 640.

The femtocell base station 640 uses the cellular base station information 546 that is entered by the user to scan 652 for a cellular base station 602. The femtocell base station 640 is able to receive the DL-MAP 628, the DCD 636, and the UCD 638 that are sent by the cellular base station 602. The femtocell base station 640 is able to decode 656 broadcast messages from the cellular base station 602, which includes the NBR-ADV (neighbor advertisement) messages 654a. The NBR-ADV message 654 may include a neighbor list 668. The neighbor list 668 may include information about other cellular base stations 602, such as the DCD 636 and the UCD 638, as well as the channel frequency, fast Fourier transform size, cyclic prefix size, channel bandwidth, etc.

The femtocell base station 640 processes the NBR-ADV messages 654a and reconstructs 660 the neighbor list 668 that is broadcast by the cellular base station 602. The femtocell base station 640 constructs 662 an NBR-ADV message 654b based on the reconstructed neighbor list 668. The femtocell base station 640 then broadcasts its own NBR-ADV message 654b to subscriber stations 604 within its coverage area.

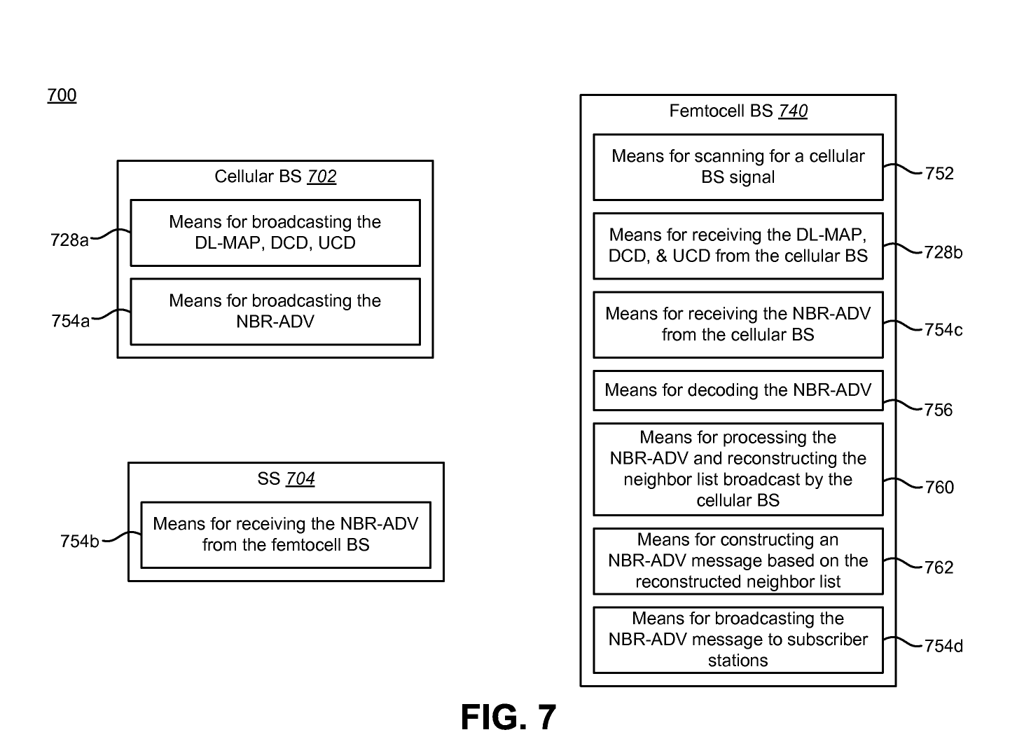

The method 600 of FIG. 6 described above may be performed by various hardware and/or software component(s) and/or module(s) corresponding to the means-plus-function blocks 700 illustrated in FIG. 7. For example, a cellular base station 702 may include means 728a for broadcasting the DL-MAP 628, the DCD 636, and the UCD 638, and means 754a for broadcasting the NBR-ADV 654a. A femtocell base station 740 may include means 752 for scanning for a cellular base station 702, means 728b for receiving the DL-MAP 628, the DCD 636, and the UCD 638 from the cellular base station 702, means 754c for receiving the NBR-ADV 654a from the cellular base station 702, means 756 for decoding the NBR-ADV 654a, means 760 for processing the NBR-ADV 654a and reconstructing the neighbor list 668 broadcast by the cellular base station 702, means 762 for constructing an NBR-ADV message 654b based on the reconstructed neighbor list 668, and means 754d for broadcasting the NBR-ADV message 654b to subscriber stations 704. A subscriber station 704 may include means 754b for receiving the NBR-ADV 654b from the femtocell base station 740.

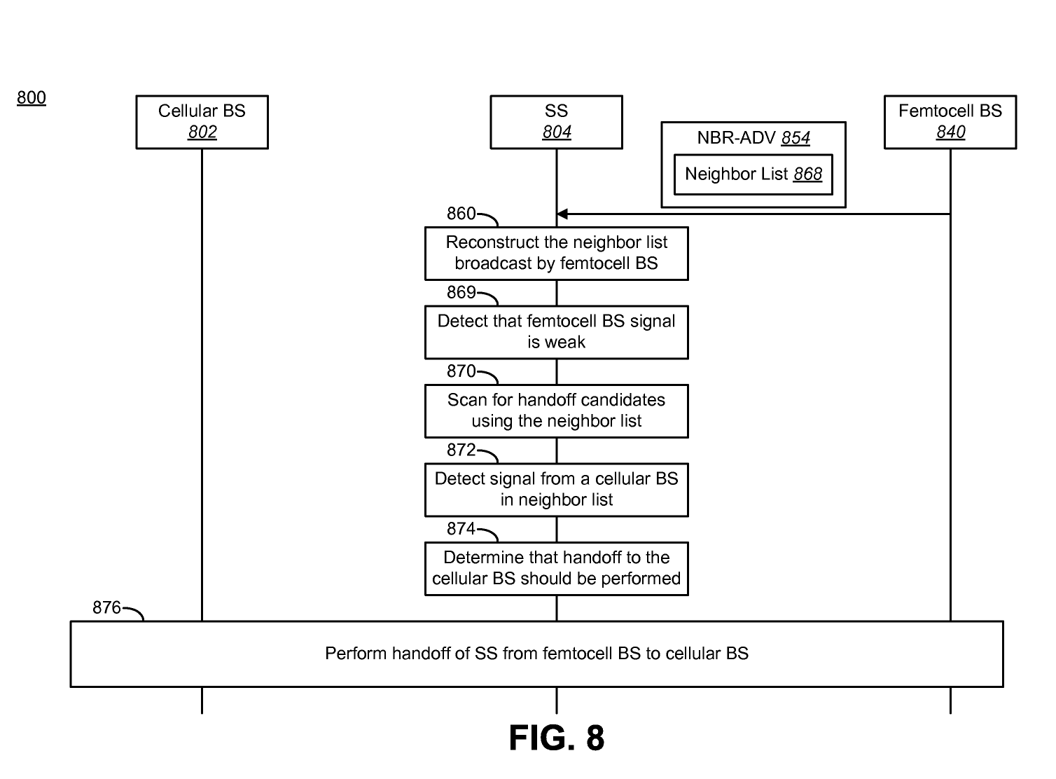

FIG. 8 illustrates a method 800 for facilitating handoff of a subscriber station 804 from a femtocell base station 840 to a cellular base station 802 (i.e., femtocell-to-cellular base station handoff). In accordance with the method 800, the subscriber station 804 receives and reconstructs 860 the neighbor list 868 that is broadcast by the femtocell base station 840 via the NBR-ADV message 854. The subscriber station 804 may receive the neighbor list 868 from the femtocell base station 840 while the subscriber station 804 is being served by the femtocell base station 840. As indicated above, the neighbor list 868 may include information about other cellular base stations 802. The femtocell base station 840 may have received the neighbor list 868 from a cellular base station 802, in the manner described above.

When the subscriber station 804 detects 869 that the signal from the femtocell base station 840 is weak (e.g., because the subscriber station 804 is moving outside of the coverage area of the femtocell base station 840), then the subscriber station 804 scans 870 for potential handoff candidates using the neighbor list 868. When the subscriber station 804 detects 872 a signal from a cellular base station 802 in the neighbor list 868, the subscriber station 804 may determine 874 that handoff to the cellular base station 802 should be performed (e.g., if the strength of the signal from the cellular base station 802 exceeds the strength of the signal from the femtocell base station 840 by a threshold amount). The subscriber station 804, cellular base station 802, and femtocell base station 840 may then perform 876 handoff of the subscriber station 804 from the femtocell base station 840 to the cellular base station 802. The subscriber station 804, cellular base station 802, and femtocell base station 840 each participate to some degree in the handoff. The femtocell base station 840 and the cellular base station 802 may be able to exchange negotiated parameters used by the subscriber station 804 in order to allow handoff optimization to occur. Negotiated parameters can include Basic Capability Parameters, Registration parameters, Security/Authentication parameters, etc. The exchange of these parameters may be via the femtocell gateway 444 to the CSN 416 to the ASN gateway 414, and vice versa.

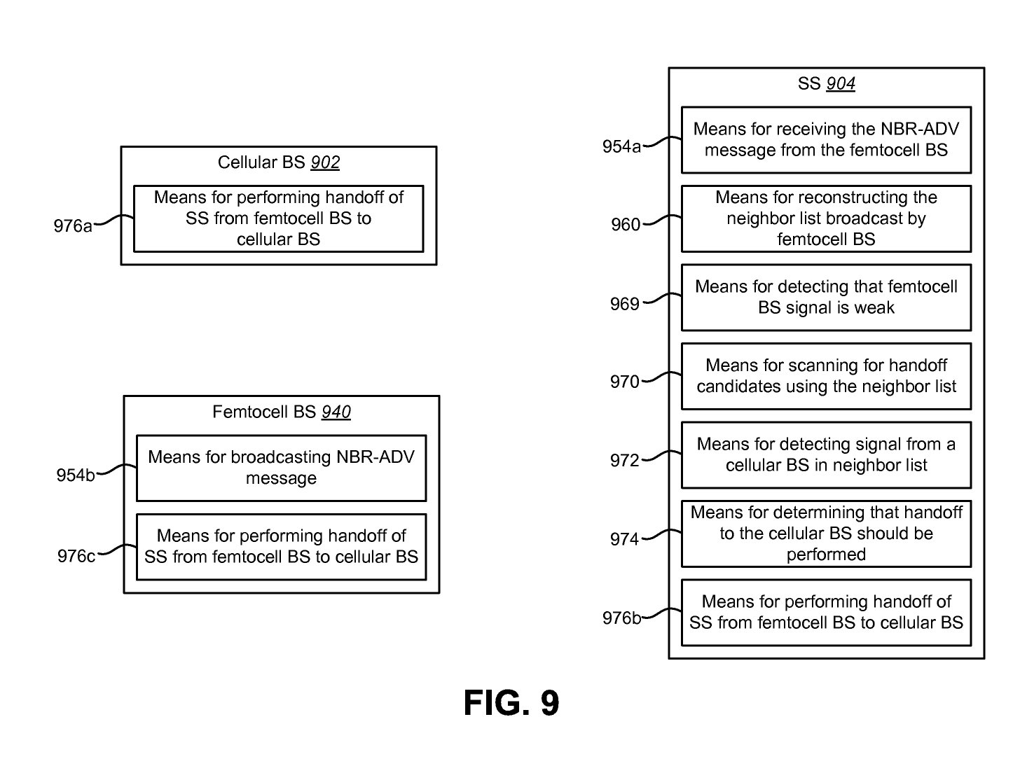

The method 800 of FIG. 8 described above may be performed by various hardware and/or software component(s) and/or module(s) corresponding to the means-plus-function blocks 900 illustrated in FIG. 9. For example, a subscriber station 904 may include means 954a for receiving an NBR-ADV message 854 from a femtocell base station 940, means 960 for reconstructing the neighbor list 868 broadcast by the femtocell base station 940, means 969 for detecting that the signal from the femtocell base station 940 is weak, means 970 for scanning for potential handoff candidates using the neighbor list 868, means 972 for detecting a signal from a cellular base station 902 in the neighbor list 868, means 974 for determining that handoff to the cellular base station 902 should be performed, and means 976b for performing handoff of the subscriber station 904 from the femtocell base station 940 to the cellular base station 902. A femtocell base station 940 may include means 954b for broadcasting an NBR-ADV message 854, and means 976c for performing handoff of the subscriber station 904 from the femtocell base station 940 to the cellular base station 902. A cellular base station 902 may include means 976a for performing handoff of the subscriber station 904 from the femtocell base station 940 to the cellular base station 902.

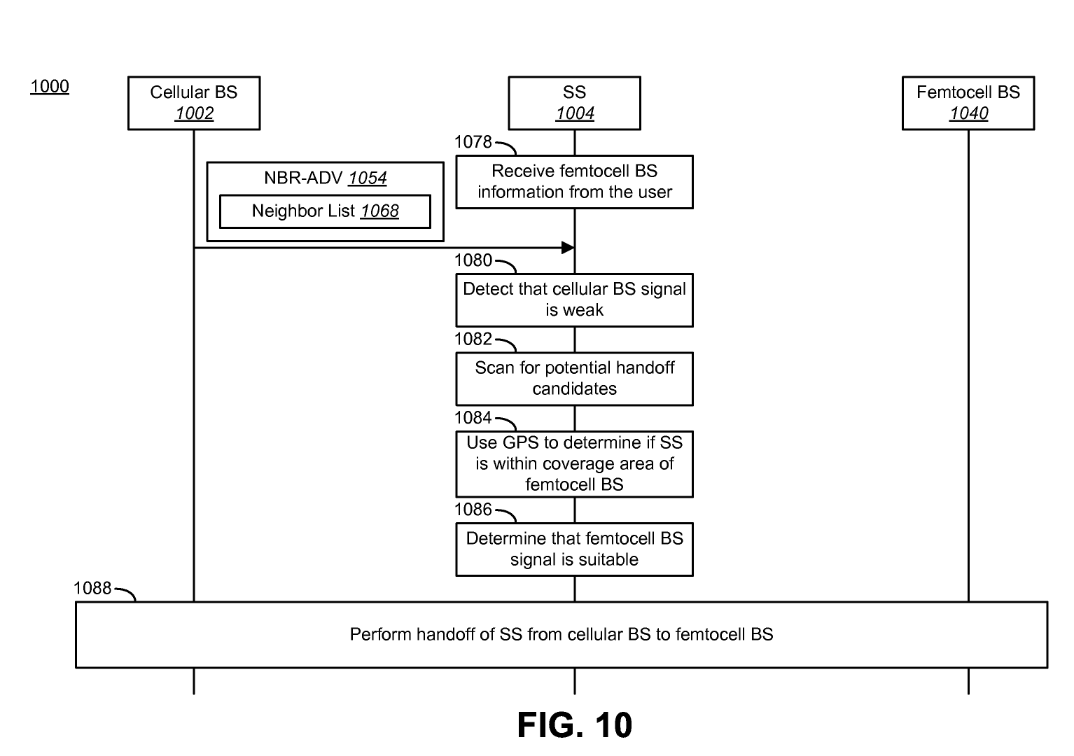

FIG. 10 illustrates a method 1000 for facilitating handoff of a subscriber station 1004 from a cellular base station 1002 to a femtocell base station 1040 (i.e., cellular-to-femtocell base station handoff).

As indicated above, the user of the subscriber station 1004 enters the femtocell base station information 550 into the subscriber station 1004. So the subscriber station 1004 receives 1078 the femtocell base station information 550 from the user. The subscriber station 1004 receives a neighbor list 1068 from a cellular base station 1002 when the subscriber station 1004 is being served by the cellular base station 1002. The neighbor list 1068 may be received via a NBR-ADV message 1054.

If at some point the subscriber station 1004 detects 1080 that the signal from the cellular base station 1002 is weak, then the subscriber station 1004 scans 1082 for potential handoff candidates. The subscriber station 1004 considers the femtocell base station 1040 as one of the potential candidates for handoff, together with the cellular base stations 1002 in the neighbor list 1068.

If the subscriber station 1004 is equipped with a GPS receiver 548, then the subscriber station 1004 may use the GPS receiver 548 to determine 1084 if the subscriber station 1004 is located within the coverage area of the femtocell base station 1040. If the subscriber station 1004 is not located within the coverage area of the femtocell base station 1040, then the subscriber station 1004 may consider other handoff candidates from the neighbor list 1068. However, if the subscriber station 1004 is located within the coverage area of the femtocell base station 1040, then handoff to the femtocell base station 1040 may be performed 1088.

Whether or not the subscriber station 1004 is equipped with a GPS receiver 548, at some point the subscriber station 1004 may determine 1086 that the signal from the femtocell base station 1040 is suitable for handoff. If it is, then the subscriber station 1004, cellular base station 1002, and femtocell base station 1040 may then perform 1088 handoff of the subscriber station 1004 from the cellular base station 1002 to the femtocell base station 1040 (the subscriber station 1004, cellular base station 1002, and femtocell base station 1040 each participate to some degree in the handoff).

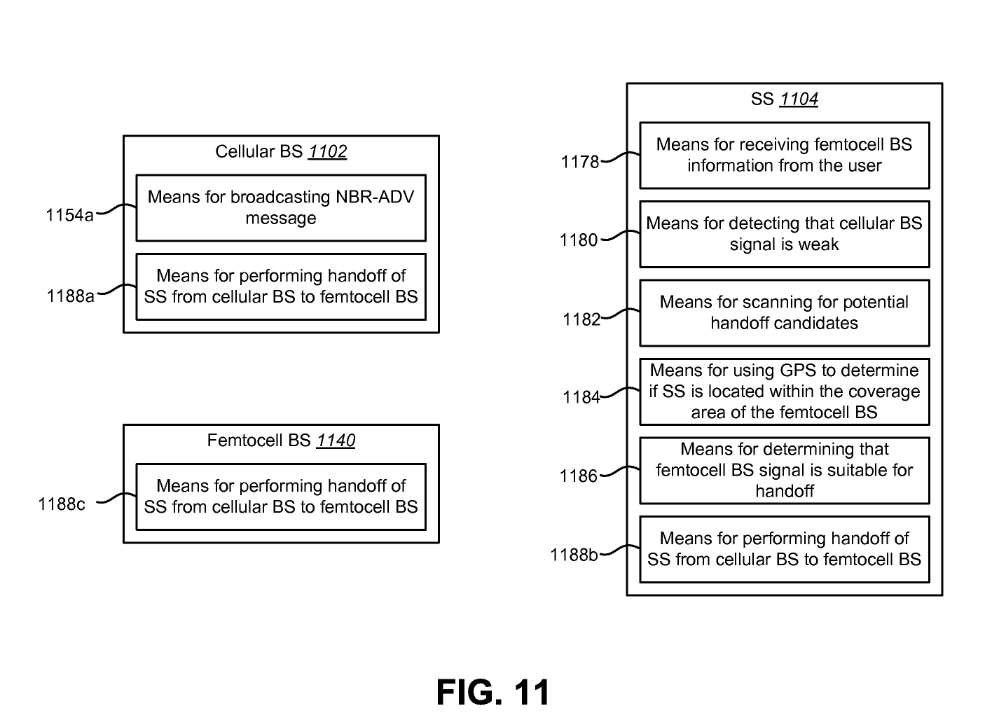

The method 1000 of FIG. 10 described above may be performed by various hardware and/or software component(s) and/or module(s) corresponding to the means-plus-function blocks 1100 illustrated in FIG. 11. For example, a subscriber station 1104 may include means 1178 for receiving femtocell base station information 550 from the user, means 1180 for detecting that the signal from the cellular base station 1102 is weak, means 1182 for scanning for potential handoff candidates, means 1184 for using a GPS receiver to determine if the subscriber station 1104 is located within the coverage area of the femtocell base station 1140, means 1186 for determining that the signal from the femtocell base station 1140 is suitable for handoff, and means 1188b for performing handoff of the subscriber station 1104 from the cellular base station 1102 to the femtocell base station 1140. A cellular base station 1102 may include means 1154a for broadcasting the NBR-ADV message 1054, and means 1188a for performing handoff of the subscriber station 1104 from the cellular base station 1102 to the femtocell base station 1140. A femtocell base station 1140 may include means 1188c for performing handoff of the subscriber station 1104 from the cellular base station 1102 to the femtocell base station 1140.

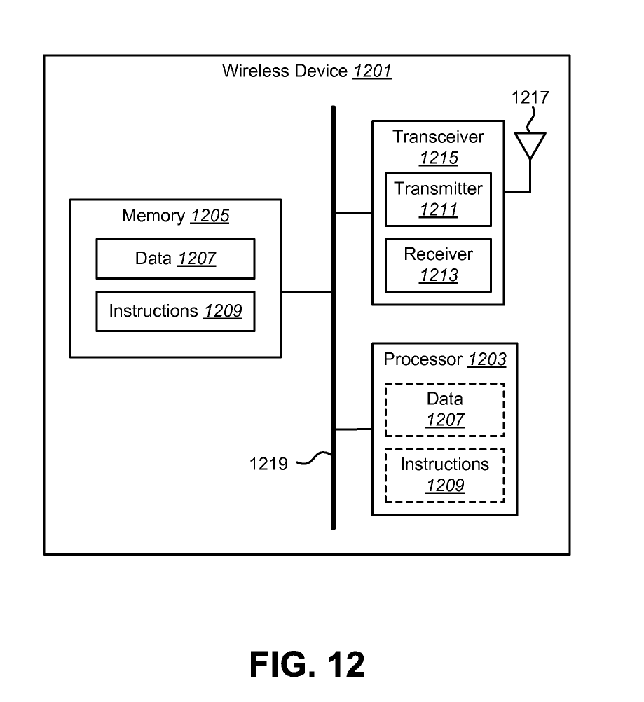

FIG. 12 illustrates certain components that may be included within a wireless device 1201. The wireless device 1201 may be a subscriber station or a base station.

The wireless device 1201 includes a processor 1203. The processor 1203 may be a general purpose single- or multi-chip microprocessor (e.g., an ARM), a special purpose microprocessor (e.g., a digital signal processor (DSP)), a microcontroller, a programmable gate array, etc. The processor 1203 may be referred to as a central processing unit (CPU). Although just a single processor 1203 is shown in the wireless device 1201 of FIG. 12, in an alternative configuration, a combination of processors (e.g., an ARM and DSP) could be used.

The wireless device 1201 also includes memory 1205. The memory 1205 may be any electronic component capable of storing electronic information. The memory 1205 may be embodied as random access memory (RAM), read only memory (ROM), magnetic disk storage media, optical storage media, flash memory devices in RAM, on-board memory included with the processor, EPROM memory, EEPROM memory, registers, and so forth, including combinations thereof.

Data 1207 and instructions 1209 may be stored in the memory 1205. The instructions 1209 may be executable by the processor 1203 to implement the methods disclosed herein. Executing the instructions 1209 may involve the use of the data 1207 that is stored in the memory 1205.

The wireless device 1201 may also include a transmitter 1211 and a receiver 1213 to allow transmission and reception of signals between the wireless device 1201 and a remote location. The transmitter 1211 and receiver 1213 may be collectively referred to as a transceiver 1215. An antenna 1217 may be electrically coupled to the transceiver 1215. The wireless device 1201 may also include (not shown) multiple transmitters, multiple receivers, multiple transceivers and/or multiple antenna.

The various components of the wireless device 1201 may be coupled together by one or more buses, which may include a power bus, a control signal bus, a status signal bus, a data bus, etc. For the sake of clarity, the various buses are illustrated in FIG. 12 as a bus system 1219.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 6, 8 and 10, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for facilitating femtocell-to-cellular base station handoff, the method being implemented by a femtocell base station, the method comprising:
receiving information about a cellular base station from a user;
receiving a neighbor list from the cellular base station, wherein the neighbor list comprises information about other cellular base stations; and
broadcasting the neighbor list to subscriber stations that are located within a coverage area of the femtocell base station.

2. The method of claim 1, further comprising using the cellular base station information received from the user to scan for the cellular base station.

3. The method of claim 1, further comprising receiving a downlink MAP, a downlink channel descriptor, and an uplink channel descriptor from the cellular base station.

4. The method of claim 1, further comprising exchanging negotiated parameters used by the subscriber station with the cellular base station.

5. A method for facilitating femtocell-to-cellular base station handoff, the method being implemented by a subscriber station, the method comprising:
receiving a neighbor list from a femtocell base station when the subscriber station is being served by the femtocell base station, wherein the neighbor list comprises information about cellular base stations; and
scanning for potential handoff candidates using the neighbor list that is received from the femtocell base station.

6. The method of claim 5, further comprising performing handoff of the subscriber station from the femtocell base station to one of the cellular base stations.

7. The method of claim 5, further comprising detecting that a signal from the femtocell base station is weak, wherein the scanning for the potential handoff candidates occurs in response to the detecting that the signal from the femtocell base station is weak.

8. A method for facilitating cellular-to-femtocell base station handoff, the method being implemented by a subscriber station, the method comprising:
receiving information about a femtocell base station from a user;
receiving a neighbor list from a cellular base station; and
scanning for potential handoff candidates using the neighbor list and the information about the femtocell base station, so that the femtocell base station is considered as one of the potential handoff candidates.

9. The method of claim 8, further comprising using a Global Positioning System (GPS) receiver to determine if the subscriber station is located within a coverage area of the femtocell base station.

10. The method of claim 8, further comprising performing handoff of the subscriber station from the cellular base station to the femtocell base station.

11. The method of claim 8, further comprising detecting that a signal from the cellular base station is weak, wherein the scanning for the potential handoff candidates occurs in response to the detecting that the signal from the cellular base station is weak.

12. A femtocell base station that is configured to facilitate femtocell-to-cellular base station handoff, comprising:
a processor;
memory in electronic communication with the processor;
instructions stored in the memory, the instructions being executable by the processor to:
receive information about a cellular base station from a user;
receive a neighbor list from the cellular base station, wherein the neighbor list comprises information about other cellular base stations; and
broadcast the neighbor list to subscriber stations that are located within a coverage area of the femtocell base station.

13. The femtocell base station of claim 12, wherein the instructions are also executable to use the cellular base station information received from the user to scan for the cellular base station.

14. The femtocell base station of claim 12, wherein the instructions are also executable to receive a downlink MAP, a downlink channel descriptor, and an uplink channel descriptor from the cellular base station.

15. The femtocell base station of claim 12, wherein the instructions are also executable to exchange negotiated parameters used by the subscriber station with the cellular base station.

16. A subscriber station that is configured to facilitate femtocell-to-cellular base station handoff, comprising:
a processor;
memory in electronic communication with the processor;
instructions stored in the memory, the instructions being executable by the processor to:
receive a neighbor list from a femtocell base station when the subscriber station is being served by the femtocell base station, wherein the neighbor list comprises information about cellular base stations; and
scan for potential handoff candidates using the neighbor list that is received from the femtocell base station.

17. The subscriber station of claim 16, wherein the instructions are also executable to perform handoff of the subscriber station from the femtocell base station to one of the cellular base stations.

18. The subscriber station of claim 16, wherein the instructions are also executable to detect that a signal from the femtocell base station is weak, and wherein the scanning for the potential handoff candidates occurs in response to the detecting that the signal from the femtocell base station is weak.

19. A subscriber station that is configured to facilitate cellular-to-femtocell base station handoff, comprising:
a processor;
memory in electronic communication with the processor;
instructions stored in the memory, the instructions being executable by the processor to:
receive information about a femtocell base station from a user;
receive a neighbor list from a cellular base station; and
scan for potential handoff candidates using the neighbor list and the information about the femtocell base station, so that the femtocell base station is considered as one of the potential handoff candidates.

20. The subscriber station of claim 19, wherein the instructions are also executable to use a Global Positioning System (GPS) receiver to determine if the subscriber station is located within a coverage area of the femtocell base station.

21. The subscriber station of claim 19, wherein the instructions are also executable to perform handoff of the subscriber station from the cellular base station to the femtocell base station.

22. The subscriber station of claim 19, wherein the instructions are also executable to detect that a signal from the cellular base station is weak, and wherein the scanning for the potential handoff candidates occurs in response to the detecting that the signal from the cellular base station is weak.

23. A femtocell base station that is configured to facilitate femtocell-to-cellular base station handoff, comprising:
means for receiving information about a cellular base station from a user;
means for receiving a neighbor list from the cellular base station, wherein the neighbor list comprises information about other cellular base stations; and
means for broadcasting the neighbor list to subscriber stations that are located within a coverage area of the femtocell base station.

24. The femtocell base station of claim 23, further comprising means for using the cellular base station information received from the user to scan for the cellular base station.

25. The femtocell base station of claim 23, further comprising means for receiving a downlink MAP, a downlink channel descriptor, and an uplink channel descriptor from the cellular base station.

26. The femtocell base station of claim 23, further comprising means for exchanging negotiated parameters used by the subscriber station with the cellular base station.

27. A subscriber station that is configured to facilitate femtocell-to-cellular base station handoff, comprising:
means for receiving a neighbor list from a femtocell base station when the subscriber station is being served by the femtocell base station, wherein the neighbor list comprises information about cellular base stations; and
means for scanning for potential handoff candidates using the neighbor list that is received from the femtocell base station.

28. The subscriber station of claim 27, further comprising means for performing handoff of the subscriber station from the femtocell base station to one of the cellular base stations.

29. The subscriber station of claim 27, further comprising means for detecting that a signal from the femtocell base station is weak, wherein the scanning for the potential handoff candidates occurs in response to the detecting that the signal from the femtocell base station is weak.

30. A subscriber station that is configured to facilitate cellular-to-femtocell base station handoff, comprising:
means for receiving information about a femtocell base station from a user;
means for receiving a neighbor list from a cellular base station; and
means for scanning for potential handoff candidates using the neighbor list and the information about the femtocell base station, so that the femtocell base station is considered as one of the potential handoff candidates.

31. The subscriber station of claim 30, further comprising means for using a Global Positioning System (GPS) receiver to determine if the subscriber station is located within a coverage area of the femtocell base station.

32. The subscriber station of claim 30, further comprising means for performing handoff of the subscriber station from the cellular base station to the femtocell base station.

33. The subscriber station of claim 30, further comprising means for detecting that a signal from the cellular base station is weak, wherein the scanning for the potential handoff candidates occurs in response to the detecting that the signal from the cellular base station is weak.

34. A computer-program product for a femtocell base station to facilitate femtocell-to-cellular base station handoff, the computer-program product comprising a computer-readable medium having instructions thereon, the instructions comprising:
code for receiving information about a cellular base station from a user;
code for receiving a neighbor list from the cellular base station, wherein the neighbor list comprises information about other cellular base stations; and
code for broadcasting the neighbor list to subscriber stations that are located within a coverage area of the femtocell base station.

35. A computer-program product for a subscriber station to facilitate femtocell-to-cellular base station handoff, the computer-program product comprising a computer-readable medium having instructions thereon, the instructions comprising:
code for receiving a neighbor list from a femtocell base station when the subscriber station is being served by the femtocell base station, wherein the neighbor list comprises information about cellular base stations; and
code for scanning for potential handoff candidates using the neighbor list that is received from the femtocell base station.

36. A computer-program product for a subscriber station to facilitate cellular-to-femtocell base station handoff, the computer-program product comprising a computer-readable medium having instructions thereon, the instructions comprising:
code for receiving information about a femtocell base station from a user;
code for receiving a neighbor list from a cellular base station; and
code for scanning for potential handoff candidates using the neighbor list and the information about the femtocell base station, so that the femtocell base station is considered as one of the potential handoff candidates.
